(19) United States
(12) Patent Application Publication
(10) Pub. No.: US 2015/0235317 A1
(43) Pub. Date: Aug. 20, 2015

(54) System for an Anonymous Equities Trading Market

(71) Applicant: Scott Jonathan Freeze, Holland, PA (US)

(72) Inventor: Scott Jonathan Freeze, Holland, PA (US)

(21) Appl. No.: 14/624,023

(22) Filed: Feb. 17, 2015

Related U.S. Application Data
(60) Provisional application No. 61/941,811, filed on Feb. 19, 2014.

(51) Int. Cl. G06Q 40/04

(52) U.S. Cl. CPC G06Q 40/04

(57) ABSTRACT

An equity trading system enables investor entities to anonymously buy and sell shares of a stock with little to no market impact. The present invention executes individual trades with a plurality of user accounts allowing for lower ask and bid prices. The system first receives a quote request for a quantity of a desired exchange-trade fund (ETF) stock. A two-sided market offer for a single share is generated based on the underlying value, the market value, and the risk assessment metric. The two-sided market offer includes a bid and an ask. The two-sided market offer is displayed to the user account for a certain amount of time. If the user account selects the ask, the system sells the quantity of the desired ETF stock to the user account. If the user account selects the bid, the system buys the quantity of the desired ETF stock from the user account.

The current application claims a priority to the U.S. Provisional Patent application Ser. No. 61/941,811 filed on Feb. 19, 2014.

### FIELD OF THE INVENTION

The present invention relates generally to an alternative method for electronic equity trading. More specifically, the present invention is a method for conducting electronic equity trading anonymously with a high degree of precision and efficiency.

### BACKGROUND OF THE INVENTION

Equity trading is the selling and buying of stocks, commodities, and financial instruments. Currently, equity trading is conducted through online trading systems where buyers and sellers are matched up based on similar bids and offers with the being disclosed throughout the process. Online equity trading has allowed anyone with a computer and adequate financial standing the ability to invest and trade in a variety of stock markets. Current systems do not protect the identities of individuals, or trading entities, and as a result expose the community to negative impacts such as fishing. Transparent equity trading exposes information which could adversely affect the fluidity of the marketplace since knowledge of who is buying and selling different types of shares may induce bias towards said individuals or entities. Anonymity eliminates the possibility of insider trading. One of the main benefits of the present invention is complete anonymity for the buyer and the seller.

An Exchange-traded fund (ETF) is a security which tracks an index, a basket of stocks, or a commodity like gold and provides a cheap and relatively safe alternative to traditional stocks. ETFs have grown in popularity in recent years due to their relatively low costs and tax advantages. An ETF is essentially a proxy for the underlying asset that provides broader exposure without requiring the individual to purchase each individual asset that the ETF tracks. ETF are traded throughout the day unlike traditional stocks which trade once at the end of the day. This provides additional flexibility to the individual. One downside to ETFs trading is the fluctuating price of ETFs in response to real-time trading. The present invention establishes a market that is devoted to ETF trading and as a result ensures lower prices than public markets.

### BRIEF DESCRIPTION OF THE DRAWINGS

FIG. 1 is a flow chart depicting the overall process of the present invention.

FIG. 2 is a flow chart depicting the process for anonymous trading in between the first account and the second account.

FIG. 3 is a flow chart depicting the process for generating the two-sided market offer.

FIG. 4 is a flow chart depicting the process for generating the two-sided market offer with the risk assessment metric being an administrator-defined value.

FIG. 5 is a flow chart depicting the process for generating the two-sided market offer with the risk assessment metric being calculated by financial analysis instruments.

FIG. 6 is a flow chart depicting the embodiment where the bid and the ask is offered under a time limit.

FIG. 7 is a flow chart depicting the process for selling shares to the user account.

FIG. 8 is a flow chart depicting the process of recording and transmitting a transaction record for the bid or the ask to the Consolidated Tape System

### DETAIL DESCRIPTIONS OF THE INVENTION

All illustrations of the drawings are for the purpose of describing selected versions of the present invention and are not intended to limit the scope of the present invention.

The present invention is a method for creating and managing an equity trading system. More specifically, the present invention allows individuals and other investing entities to anonymously and electronically buy and sell exchange-trade funds (ETFs) with little to no market impact. The reduced direct market impact allows for trading at significantly lower prices. This allows investors to move large blocks of equities at low prices and without having to divide the large order into smaller lots, also known as an iceberg order. The present invention is described in relation to trading services for ETF securities, but may be altered and configured for alternative stock types as well. In the preferred embodiment, the system implementing the steps of the present invention is an Internet-based software application that is operated and managed by at least one server and at least one administrator. The system of the present invention may be run and or financially supported by any entity or individual, but the preferred is a financial institution such as a liquidity provider. A liquidity provider connects brokers and other similar entities together and as a result has access to large pools of clients, an essential prerequisite for the present invention. The method of the present invention connects clients from these large pools together through an anonymous trading network creating a separate and private market. The present invention may be viewed, accessed, and interacted with by different users from any kind of web-enabled computing device such as a smart phone, a desktop computer, a laptop, and a tablet personal computer.

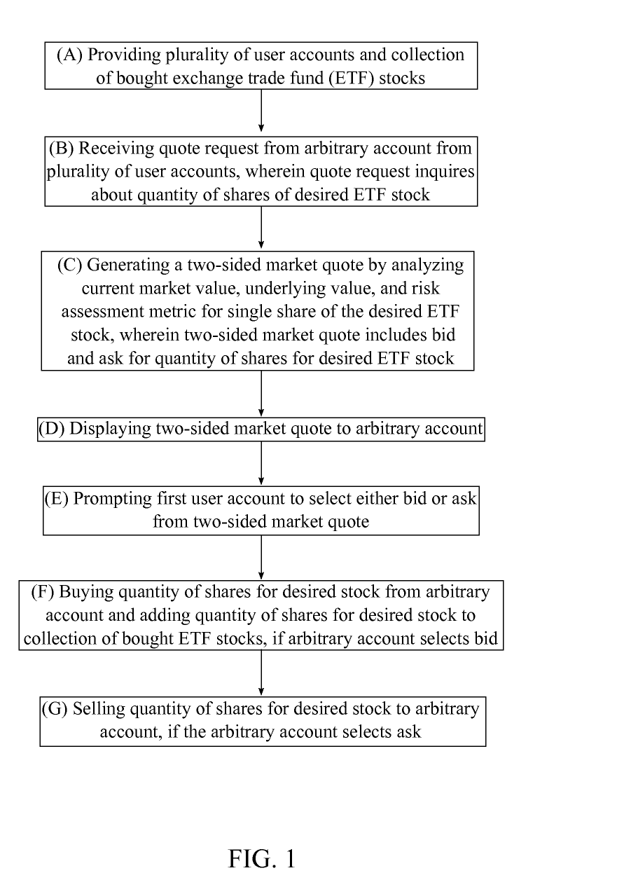

Referring to FIG. 1, the overall process of the present invention begins with the system being provided with a plurality of user accounts and a collection of bought ETF stocks. Each user account of the plurality of user accounts represents an investor or market participant. Market participants may range from individual investors to large financial entities. The collection of bought ETF stocks is an aggregation of different types of ETFs; the amount and type of ETFs in the collection may vary throughout the various operations of the present invention. The method of the present invention begins when the system receives a quote request from an arbitrary account from the plurality of user accounts. The quote request inquires about the financial standing of a quantity of shares of a desired ETF stock. The overall process continues with the system generating a two-sided market quote for the arbitrary account by analyzing a variety of values for a single share of the desired ETF stock. The two-sided market includes a bid and an ask for the quantity of shares for the desired ETF stock; the bid is an offer to buy shares from the arbitrary user; and the ask is an offer to sell shares to the arbitrary account. Values which feed into determining the two-sided market offer include, but are not limited to, a current market value, an underlying value, and a risk assessment metric. Once the two-sided market offer is calculated, it is then displayed to the arbitrary account through a web-enabled computing device. The arbitrary account is then prompted to select either the bid or the ask from the two-sided market quote; the two-sided market quote is time sensitive as ETFs are traded during the day. If the arbitrary account selects the bid, the system purchases the quantity of shares for the desired stock from the arbitrary account and adds said shared to the collection of bought ETF stocks. If the arbitrary account selects the ask, the system sells the quantity of shares for the desired stock to the arbitrary account. The overall process is repeated for each quote request from the plurality of user accounts.

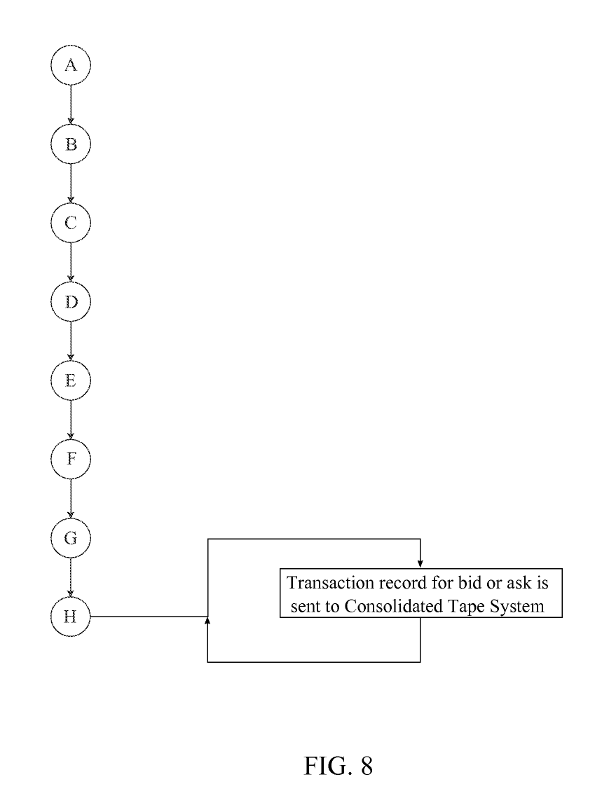

It is an aim of the present invention to allow a plurality of user accounts to electronically trade ETF, or other types of securities, in an anonymous fashion. This is achieved through the implementation of an intermediate entity, more specifically the system. The plurality of user accounts may only trade with the system. The transaction information is encrypted and stored on the at least one server until the end of the transaction. In the preferred embodiment, transaction records for the bid or the ask are submitted to the Consolidated Tape System after step (G) as seen in FIG. 8, the execution of the trade. The present invention may delay the submission of trade activity by a certain time increment in order to further decrease market impact; the time increment may be preset depending on the stock trading regulations.

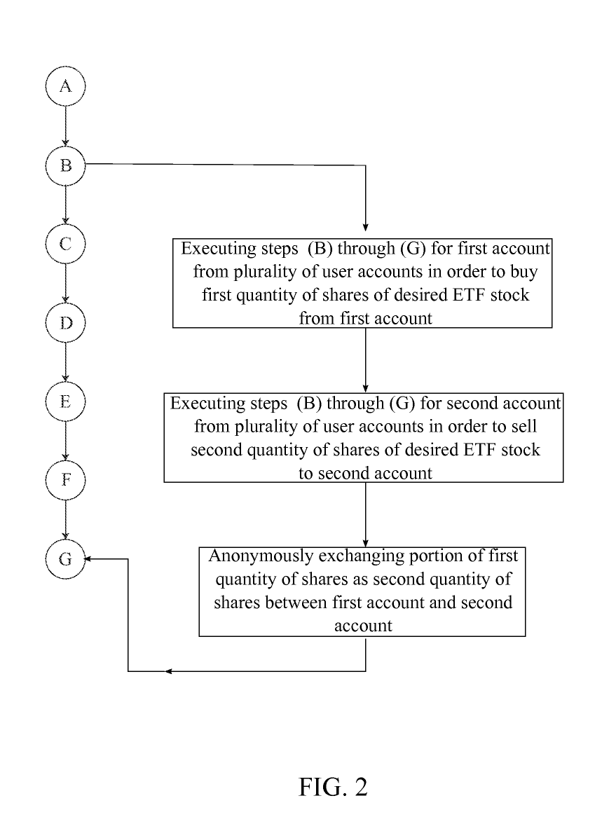

By both selling and buying shares with a plurality of user accounts, the method of the present invention essentially matches up clients anonymously. Biased trading is illegal in stock trading practices as non-public information is used to predict stock standing; this gives an unfair advantage to individuals with access to said information. Anonymous trading is one of the main features of the present invention. Anonymous trading ensures that there is no chance that insider trading may occur. For example, in one instance a first account and a second account are interested in selling and buying the same desired ETF stock, respectively. First, the system executes steps (B) through (G), as seen in FIG. 2, for the first account from the plurality of user accounts in order to buy a first quantity of shares of the desired ETF stock from the first account, as seen in FIG. 2. Next, the system repeats the steps (B) through (G), as seen in FIG. 2, for the second account from the plurality of user accounts in order to sell a second quantity of shares of the desired ETF stock to the second account. This process anonymously exchanges a portion of the first quantity of shares as the second quantity of shares between the first account and the second account. It is important to notice that the system's transactions with the first account and the second account do not occur simultaneously nor are the clients matched up. The transactions may occur at different times of the day, month, or year; the example simply describes the transfer of a certain quantity of shares of a specific ETF stock from one user account to another user account without disclosing who is selling and buying said shares.

The present invention also follows a number of secondary processes, sub-steps of the overall processes. One of the secondary processes includes the generation of the two-sided market offer. Once a request quote is received, the system then retrieves a variety of values for the single share of the desired ETF stock in order to generate the two-sided market offer. One of the values is the underlying value; the total value of the underlying securities which the ETF tracks. The underlying value is disclosed daily by the ETF sponsors. Another value is the current market value; this is the price of a single share of the desired ETF on a public exchange at the time of the quote request. The last value is the risk assessment metric which balances reward and risk for said particular transaction and modifies the two-sided market accordingly. The risk assessment metric is calculated through the use financial algorithms based on the allowable risk preset by the liquidity provider. In one embodiment, the risk assessment metric is entered into the system by the administrator in the form of an administrator-defined value. In alternative embodiments, additional values and metrics may also be taken into consideration for the two-sided market offer. Additional values include stock type, underlying securities, average daily volume, stock's volatility, and price discrepancies between the ETF and its underlining portfolio to name a few non-limiting examples.

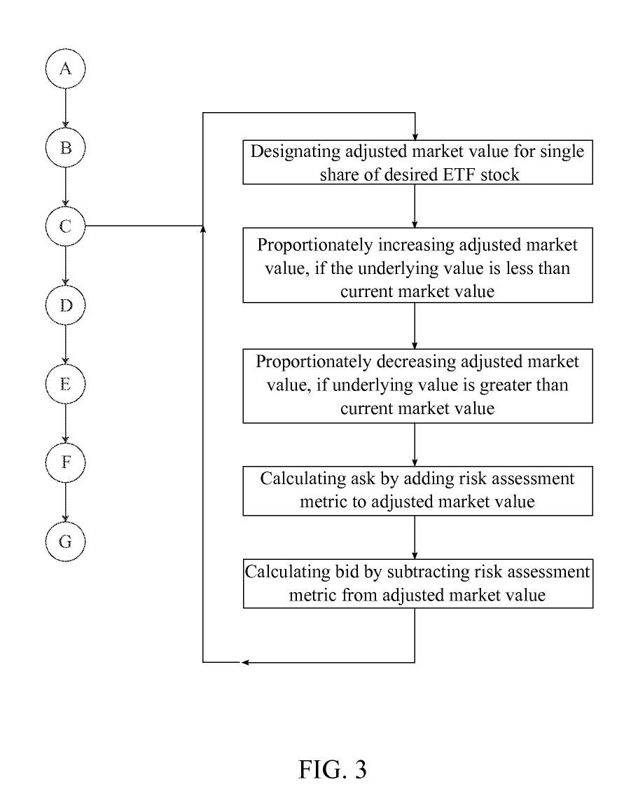

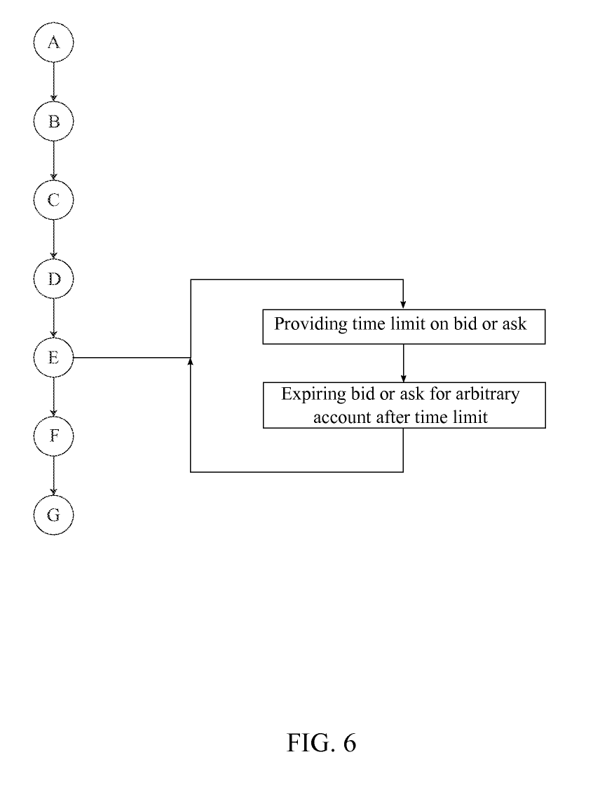

The first step in generating a two-sided market offer is designating an adjusted market value for the bid and the ask for the single share of the desired ETF stock. The adjusted market value weighs the underlying value and the current market value of the desired ETF stock and calculates an intermediate price that reflects the potential value of the share to the system, individual, or other type of investing entity, as seen in FIG. 3. The adjusted market value is also known as a fair-value in the industry. Various algorithms and equations may be used to calculate the adjusted market value. In general, if the underlying value is less than the current market value, the adjusted market value is increased proportionately. This takes into consideration the premium price at which the ETF is being sold on the public exchange. Alternatively, if the underlying value is greater than the current market value, the adjusted market value is proportionately decreased. This ensures the adjusted market value takes into consideration the discount price at which the ETF is being sold on the public exchange. The next step is applying the risk assessment metric to the adjusted market value to generate the bid and the ask. The bid is generated by subtracting the risk assessment metric from the adjusted market value. The ask is generated by adding the risk assessment metric to the adjusted market value. The ask and the bid make up the two-sided market offer and both are displayed to the arbitrary account to choose from. In one embodiment, the two-sided market offer expires after a certain time limit as the market varies as a function of time as seen in FIG. 6.

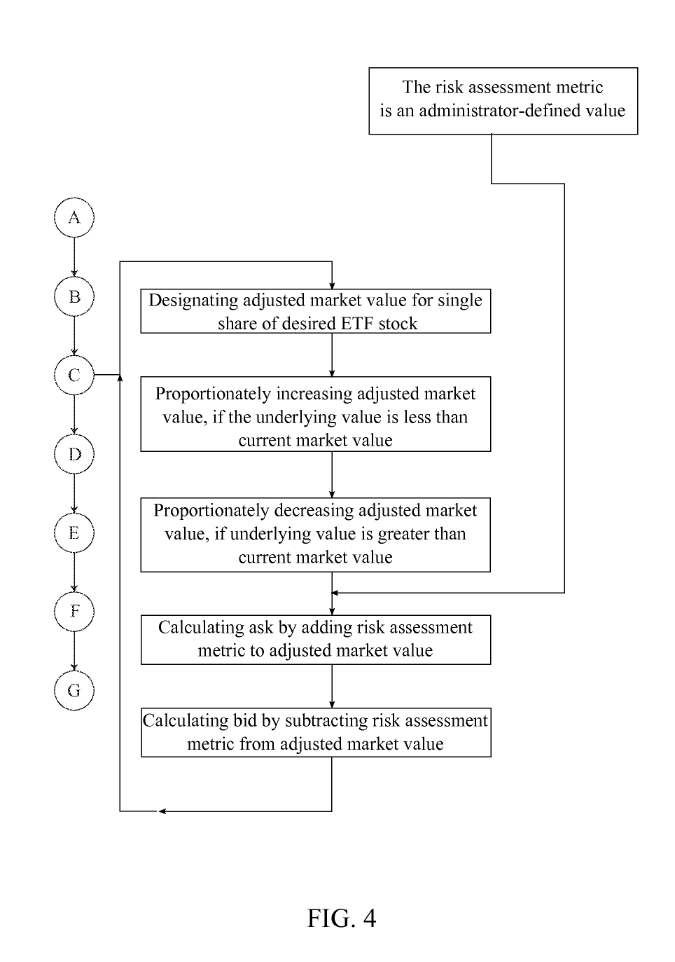

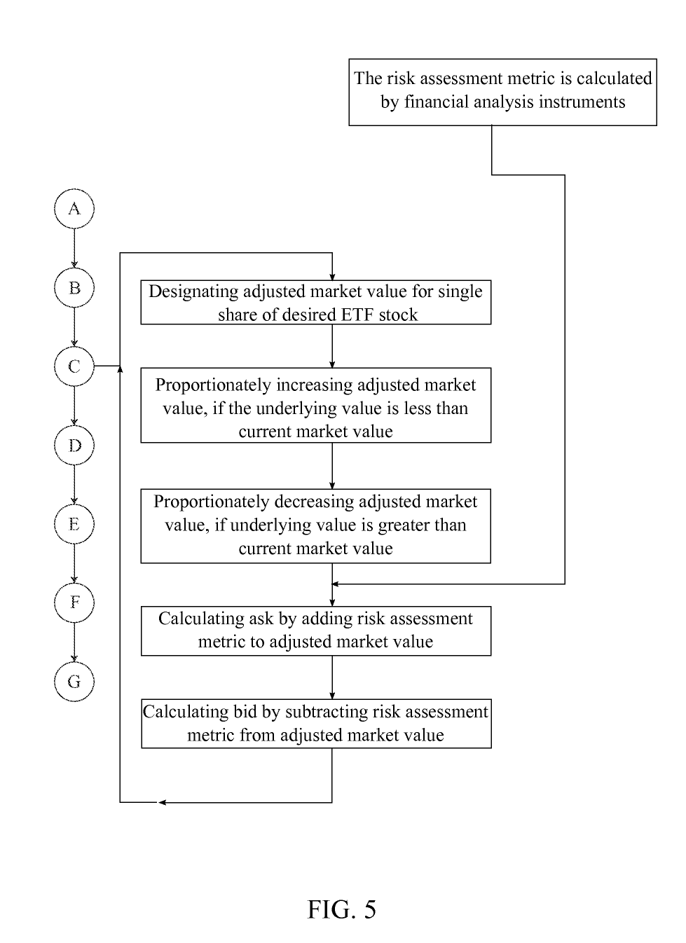

The risk assessment metric may be generated through a variety of means. In one embodiment, the risk assessment metric is entered by the administrator as an administrator-defined value as seen in FIG. 4. In another embodiment, financial analysis instruments are utilized to calculate an optimal risk assessment metric that suits the risk and reward limits of the system as seen in FIG. 5. One of the financial analysis means may include a pre-trade analysis, a common process used in the industry to calculate trade costs as a result of a single transaction. The pre-trade analysis may take into consideration average daily volume, stock's volatility and history, price discrepancies between the ETF and the underlying securities, transaction quantity, and ask/bid price to name a few non-limiting examples. In one embodiment, the risk assessment metric is the same for both the bid and the ask. In an alternative embodiment, the risk assessment metric for the bid and the ask is different, tailored to either value.

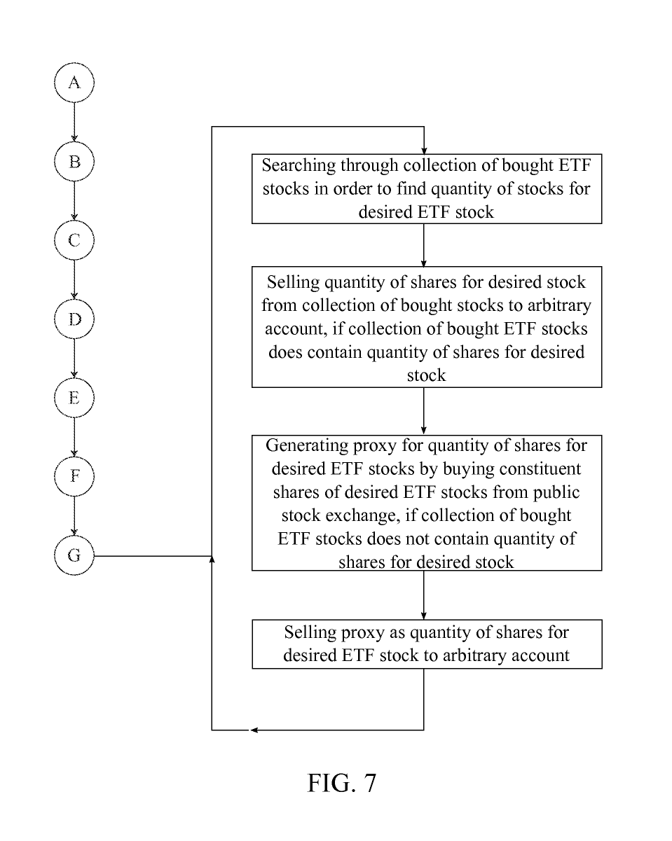

Another secondary process of the present invention relates to executing the trade. If the arbitrary user selects the bid from the two-sided market offer, then the system executes the buy from the arbitrary user. If the arbitrary user selects the ask, then the system goes through a slightly more complicated method as seen in FIG. 7. First the system searches through the collection of bought ETF stocks in order to find the quantity of stocks for the desired ETF stock. If the collection of bought ETF stocks does contain the quantity of shares for the desired stock, the quantity of shares for the desired stock is sold to the arbitrary account. If the collection of bought ETF stocks does not contain the quantity of shares for the desired stock, the system generates a proxy by buying constituent shares of the desired ETF stocks form a public exchange. The constituent shares comprise the underlying securities that the ETF follows. The proxy is then sold to the arbitrary account.

Although the invention has been explained in relation to its preferred embodiment, it is to be understood that many other possible modifications and variations can be made without departing from the spirit and scope of the invention as hereinafter claimed.

What is claimed is:

1. A method for an anonymous equities trading market by computer-executable instructions stored on a non-transitory computer-readable medium, the method comprises the steps of:
(A) providing a plurality of user accounts and a collection of bought exchange trade fund (ETF) stocks;
(B) receiving a quote request from an arbitrary account from the plurality of user accounts, wherein the quote request inquires about a quantity of shares of a desired ETF stock;
(C) generating a two-sided market quote by analyzing a current market value, an underlying value, and an risk assessment metric for a single share of the desired ETF stock, wherein the two-sided market quote includes a bid and an ask for the quantity of shares for the desired ETF stock;
(D) displaying the two-sided market quote to the arbitrary account;
(E) prompting the arbitrary account to select either the bid or the ask from the two-sided market quote;
(F) buying the quantity of shares for the desired stock from the arbitrary account and adding the quantity of shares for the desired stock to the collection of bought ETF stocks,
if the arbitrary account selects the bid; and
(G) selling the quantity of shares for the desired stock to the arbitrary account,
if the arbitrary account selects the ask.

2. The method for an anonymous equities trading market by computer-executable instructions stored on a non-transitory computer-readable medium, the method as claimed in claim 1 comprises the steps of:
executing steps (B) through (G) for a first account from the plurality of user accounts in order to buy a first quantity of shares of the desired ETF stock from the first account;
executing steps (B) through (G) for a second account from the plurality of user accounts in order to sell a second quantity of shares of the desired ETF stock to the second account; and
anonymously exchanging a portion of the first quantity of shares as the second quantity of shares between the first account and the second account.

3. The method for an anonymous equities trading market by computer-executable instructions stored on a non-transitory computer-readable medium, the method as claimed in claim 1 comprises the steps of:
designating an adjusted market value for the single share of the desired ETF stock;
proportionately increasing the adjusted market value,
if the underlying value is less than the current market value;
proportionately decreasing the adjusted market value,
if the underlying value is greater than the current market value;
calculating the ask by adding the risk assessment metric to the adjusted market value; and
calculating the bid by subtracting the risk assessment metric from the adjusted market value.

4. The method for an anonymous equities trading market by computer-executable instructions stored on a non-transitory computer-readable medium, the method as claimed in claim 3, wherein the risk assessment metric is an administrator-defined value.

5. The method for an anonymous equities trading market by computer-executable instructions stored on a non-transitory computer-readable medium, the method as claimed in claim 3, wherein the risk assessment metric is calculated by financial analysis instruments.

6. The method for an anonymous equities trading market by computer-executable instructions stored on a non-transitory computer-readable medium, the method as claimed in claim 1 comprises the steps of:
providing a time limit on the bid or the ask; and
expiring the bid or the ask for the arbitrary account after the time limit.

7. The method for an anonymous equities trading market by computer-executable instructions stored on a non-transitory computer-readable medium, the method as claimed in claim 1 comprises the steps of:
wherein the arbitrary account selects the ask during step (G);
searching through the collection of bought ETF stocks in order to find the quantity of stocks for the desired ETF stock;
selling the quantity of shares for the desired stock from the collection of bought stocks to the arbitrary account,
if the collection of bought ETF stocks does contain the quantity of shares for the desired stock;
generating a proxy for the quantity of shares for the desired ETF stocks by buying constituent shares of the desired ETF stocks from a public stock exchange,
if the collection of bought ETF stocks does not contain the quantity of shares for the desired stock; and
selling the proxy as the quantity of shares for the desired ETF stock to the arbitrary account.

8. The method for an anonymous equities trading market by computer-executable instructions stored on a non-transitory computer-readable medium, the method as claimed in claim 1, wherein a transaction record for the bid or the ask is sent to the Consolidated Tape System after step (G).
